(19) United States
(12) Patent Application Publication
(10) Pub. No.: US 2026/0109379 A1
(43) Pub. Date: Apr. 23, 2026

(54) METHOD FOR AUTOMATICALLY EVALUATING TRACK MEASUREMENT DATA

(71) Applicant: HP3 Real GmbH, Wien (AT)

(72) Inventor: Bernhard Lichtberger, Gmunden (AT)

(21) Appl. No.: 19/116,298

(22) PCT Filed: Sep. 25, 2023
(86) PCT No.: PCT/AT2023/060332

§ 371 Date: Mar. 27, 2025

(30) Foreign Application Priority Data
Oct. 25, 2022 (AT) A 50824/2022

(51) Int. Cl. B61L 23/04; G01N 25/72

(52) U.S. Cl. CPC B61L 23/042; G01N 25/72

(57) ABSTRACT

A method automatically evaluates wavelet-transformed track measurement data (1) of the track geometry and/or the ballast bed with a computing device. First, a measurement series of the track measurement data (1) to be evaluated, assigned to a track section, is wavelet-transformed with a plurality of wavelets of different wavelengths. A type of thermal image, in which the wavelength above the position in a track and the wavelet transformed track measurement data are provided as thermal information, and a wavelet power density spectrum (3) are formed from these wavelet transformed track measurement data and, in addition, a signal strength diagram (4) is calculated for various wavelength ranges (D0, D1, D2, D3) The type, position, extent and size of the track defects are determined from the thermal image by determining the local position (B, C, D, F), the extent and the associated wavelength ranges (E, D0, D1, D2, D3) of predominant track defects, in particular from the contour lines of the thermal image.

### FIELD OF THE INVENTION

The invention relates to a method for the automatic evaluation of wavelet transformed track measurement data of the track geometry and/or the ballast bed with a computing device.

### DESCRIPTION OF THE PRIOR ART

An evaluation of measurement data obtained by track measuring vehicles using wavelet transformation is known from the state of the art. For example, discloses CN 111979859 A a system for detecting track irregularities, whereby data obtained from acceleration sensors is evaluated using a wavelet transformation. A method for detecting long-wave track irregularities is also known from CN 104032629 B, whereby the data obtained from angular acceleration sensors is evaluated using wavelet transformations. CN 104947555 A shows another method for recognising track irregularities, which are determined by means of Fourier transformations of the wavelengths on which the irregularities are based.

The majority of railway lines have a ballasted superstructure. The sleepers lie in the ballast. The ballast is rounded, partially broken and worn down by the wheel forces of the trains travelling over it. This causes irregular settlements in the ballast and shifts in the lateral geometry of the track. The settling of the ballast bed causes defects in the longitudinal height, cant (in curves), twisting, track and alignment. The defects in turn increase the acting forces which in turn have a destructive effect on the ballast and the subsoil.

If certain limits or safety limits set by the railway authorities for these geometric sizes are exceeded, maintenance work is planned and carried out. Track maintenance machines are used to rectify and correct these geometric track defects. Prior to the track construction work, the tracks are recorded with regard to the geometric track position and correction values are derived from this, which are transferred to the machine to carry out the corrective measures.

For measuring the correction work, the machines are equipped with a tracking measuring system that checks the track position for compliance with specified tolerances (.AT516278A1)

Tamping machines with a fully hydraulic tamping drive (AT513973a1) record the ballast properties during operation with the aid of sensors integrated into the fully hydraulic tamping drive (AT515801A1). By evaluating the course of the forces, the tamping speed, the tamping distance and the time sequence, ballast bed parameters such as ballast bed hardness, compaction force, ballast bed stiffness and ballast damping can be measured and recorded for each tamped sleeper (AT520117A1).

The degree of ballast contamination can be determined by these parameters. From a degree of contamination of more than 30% fine material in the ballast, the track geometry can no longer be permanently corrected by tamping. The ballast must then be replaced or cleaned. Ballast bed cleaning machines are used for this purpose.

At significant differences in track stiffness (such as retracted rail joints, transitions to bridges or tunnels), the high wheel-rail forces cause the sleepers to strike the ballast bed and destroy (and round off) the ballast. Such spots are often visible externally as white spots (escaping rock dust). At these points, the driving dynamics lead to the ballast being pulverised and these spots are indicated by escaping mineral dust. These individual defects usually have an extent of a few metres, but tend to spread further and grow rapidly in their defect amplitude. This often results in safety-critical defects that need to be rectified immediately or, better still, preventively. These defects can be rectified by tamping machines that work in single defect rectification mode.

Different settlements of the ballast bed result in sleeper bumps. These typically occur at a distance of 2-5 metres (D0 strip). They can also be remedied by track tamping machines.

Defect wavelengths in the range (D1 band) of 3 to 25 m typically characterise track defects caused by interaction with the vehicles (axle spacing in the bogies, bogie spacing or single axle spacing, suspension and damping behaviour of the running gear). The settlements are caused by rearrangement, abrasion and breakage of the ballast grains. Track position defects in this wavelength range can be rectified by track tamping machines. It is known that a highly contaminated ballast bed has high compaction forces. There is no leeway between the ballast bed grains because they are filled with fine material. This increases the compaction forces that have to be applied to move and compact the ballast. At the same time, such contaminated track beds have a reduced durability of the corrected track geometry, as the frictional forces and the interlocking between the ballast bed grains are low.

Longer-wavelength defects (D2 band) between 25 and 70 metres are defects in the subgrade adjacent to the ballast. Typically, the cause is inadequate drainage or poor load-bearing behaviour (soaked loam or clay, etc.), which is why longer-wave settlements occur. An obstruction of the drainage can be caused, for example, by the construction of a noise barrier, which hinders the drainage of water from the bedding. The longer the wavelength of the defects, the more likely it is that their cause can be found further below the ballast layer. Although these defects can be levelled out by track tamping machines, they do not eliminate the cause of the defect in the long term. A lasting remedy is only possible through track bed cleaning or subgrade rehabilitation This involves using a subgrade rehabilitation machine (or other non-mechanised methods) to apply a subgrade protection layer, If the track defects are due to inadequate drainage, this must be improved. This can be done by excavating the railway trenches or by cleaning and flushing the drainage channels.

Defects with a wavelength greater than 70 m (D3 band) are due to inadequate load-bearing behaviour of the subsoil. The use of subgrade improvement machines to install a load-distributing subgrade protection layer or soil replacement can help here. Experience has shown that this type of defect is often characterised by long-wave torsion.

The railway company divides track sections into route classes. The track classes are distinguished by the travelling speed range in which they are operated. Each track class is assigned its own limit values for the standard deviations of the track defects. This assignment is made for the track geometry variables direction, height, crossfall, twist and track. There are limit values that are used for planning track work (to be carried out within a certain period of time) and critical values that require immediate rectification or restriction of operation (up to closure).

The measurement of ballast bed properties using fully hydraulic tamping drives, on the other hand, records the properties of the ballast in great detail and precisely to the sleeper (AT515801B1) and thus allows an objective assessment.

Track maintenance is currently planned on the basis of track geometry measurements. Track measurement vehicles drive over the tracks at regular intervals and record their geometric condition. The track is usually divided into sections of around 200 metres in length and the standard deviation of the height, direction, cant and twist is recorded. In addition to these statistical values, singular individual defects are also measured. If the statistical values exceed certain comfort tolerances, maintenance work is planned and carried out.

The track defects are assessed on the basis of standard deviations or moving averages of the measurement signals. The determination of the exact position, extent, type and cause of the track defects remains undetermined or fuzzy. The planning and execution of track work is usually based on predetermined rules and regulations or the experience of the person responsible. Ballast bed and subsoil properties are generally not included in the assessment as there is usually no objective measurement data available.

Sections 200 metres long are usually evaluated, for which a track quality index is specified (TQI track quality index). This is usually calculated from a weighted composition of the standard deviations of the various track geometry parameters or the longitudinal height alone.

The disadvantage of these methods is that they are not based on an analysis of the causes of the track defects and therefore often use unsuitable methods to correct them. This results in increased maintenance costs. An incorrect method can, for example, lead to an increased and rapidly rising number of tamping works. The correct method would have been ballast bed cleaning. This not only leads to an increase in maintenance costs, but also has a detrimental effect on the service life of the track components (ballast, rails, sleepers, etc.) and increases the LCC. The ballast can be extremely damaged if left in place for long periods. A large proportion of fines and organic material or soil pressed upwards from the subsoil may have filled the spaces between the ballast grains. It is known from practice that the track position of such ballast structures cannot be permanently corrected with track tamping machines.

It is also known from practical experience that individual defects occur randomly distributed throughout the track. Around 40% of these localised defects can be permanently rectified. 60% of these defects develop again within a short time. Tracks with good ballast condition are tamped on average approximately every four years. Individual defects that indicate destruction of the ballast require maintenance measures approx. every 1-3 months. During each tamping operation, some of the ballast is damaged by the tamping tools due to the high compaction forces. Long tamping cycles are therefore of great economic importance.

Points in the track with high ballast hardness (with high stiffness) form high points in the track. The more varied the stiffness fluctuations in the track bed, the larger the force interaction between wheel and rail, the higher the load on the track and the faster the track geometry deteriorates. Singular short defects in the track tend to extend in the longitudinal direction under the high dynamic forces acting in the track, increase in the height of the track defect and produce subsequent defects due to the track vehicles being excited.

The application of artificial intelligence methods is state of the art. The AI models used can be divided into different categories. A distinction is made between artificial neural networks (ANN Artificial Neural Networks), adaptive neural fuzzy interference systems (ANFIS), decision support systems (DSS Decision Support Systems) and artificial learning models. Artificial intelligence models have the ability to map complex track position deterioration behaviour or the type, position, extent and wavelength of track position defects with high accuracy.

AI models must be trained with training data sets. They are then tested with test data sets.

By means of a comparative LCC analysis of different maintenance methods (tamping with ever shorter maintenance cycles instead of actually necessary track cleaning), their costs can be compared with each other. In order to compare different maintenance strategies with each other, so-called standard elements or standard kilometres are determined, for example. For this purpose, the expert knowledge of railway engineers or real calculated figures and costs are used, for example. The standard kilometres are subdivided into categories such as substructure quality, radii, traffic load, superstructure shape and number of tracks.

### SUMMARY OF THE INVENTION

The invention is based on the task of providing a method for automatically evaluating and analysing a measurement series of track measurement data, in particular a track geometry variable and/or the ballast bed. The analysis should automatically be able to determine the type, position, extent and size of the track defects. The method should also automatically generate suggestions for remedying the track defects and provide a general assessment of the track condition.

The invention solves the problem set with the features of independent claim 1. Advantageous further embodiments of the invention are shown in the subclaims.

The invention is characterised in that firstly a measurement series of the track measurement data to be evaluated, assigned to a track section, is wavelet-transformed with a plurality of wavelets of different wavelengths and a type of thermal image, in which the wavelength above the position in a track and the wavelet transformed track measurement data are provided as thermal information, and a wavelet power density spectrum are formed from these wavelet transformed track measurement data and, in addition, a signal strength diagram is calculated for various wavelength ranges, after which, in order to determine the type, position, extent and size of the track defects from the thermal image, the local position, the extent and the associated wavelength ranges of predominant track defects are determined, in particular from the contour lines of the thermal image.

To do this, a measured measurement series of track measurement data (e.g. longitudinal height, direction, twist, cross-level, bedding hardness, compaction force, ballast stiffness, ballast damping) is analysed with regard to the local position and extent and its wavelength content using the wavelet method and, if necessary, the fractal method. It is important to note that, in contrast to Fourier transformations, wavelet transformations retain positional information about the defects, meaning that individual defects can be assigned to specific positions in the track. In addition, a wavelet power density spectrum is calculated and a type of thermal image is generated in which the position, extent and size of the track defect can be seen in colour or through (height) lines of equal intensity.

In addition, a double-logarithmic fractal diagram can be generated, from which the track defects can be calculated as a function of wavelength (from the slope and position in the wavelength range). The type, position and extent of the track defect are calculated automatically according to the analysed range of wavelengths contained in the measurement series. The intensity and size of the track defects are inferred from the integral over the corresponding wavelength band of the wavelet power density spectrum. All of this is used for the automatic evaluation of the measured measurement series of a track geometry variable and the automatic determination of the type, position, extent and size of the track defects. The analysis automatically generates suggestions for how to rectify the track defects. The analysis also provides a general assessment of the condition of the track in question.

According to the invention, an expert system is created which, with the help of objective figures, automatically allows the type, position and extent of the track defects to be assigned. However, in addition to track position measurements, information about the ballast is also available for this evaluation. A possible mutual influence of the various measured variables is probably not recognised by this expert system.

For this reason, this expert system is to be used to train an artificial intelligence that integrates these hidden relationships into the evaluation, takes them into account and thus leads to greater precision.

Wavelets were born out of the idea of dividing a track into shorter sections and using the Fourier transform to find those points where short-wavelength track defects occur (short-path Fourier transform).

In contrast to the sine and cosine functions of the Fourier transform, wavelets have locality in the wavelength spectrum and in the spatial spectrum. In simple terms, the wavelet transform acts as if the signal were sieved piece by piece with a filter of a certain bandwidth. In this way, certain localised defect wavelength ranges are found. A simple track defect signal results in a two-dimensional representation of the wavelengths over the location. There are various bandpass wavelet functions that are used. Typical are the Morlet wavelet and the Mexican hat.

The wavelet of the Mexican hat, for example, is described mathematically as follows:

$$ψ ( x ) = \frac{2}{\sqrt{3} \cdot \sqrt[4]{π}} \cdot ( 1 - {x}^{2} ) \cdot {e}^{- \frac{{x}^{2}}{2}}$$

The wavelet transformed track measurement data is calculated as:

$$𝒲 ( F ( x ) ) ( a , b ) = \frac{1}{\sqrt{\vert a \vert}} \cdot {\int }_{- ∞}^{+ ∞} F ( x ) \cdot \overline{ψ ( \frac{x - b}{a} )} dx$$

and is called the wavelet transformed track measurement data of F(x) with respect to ψ.

With b as the displacement factor, the wavelet is shifted through the function F(x) (e.g. the measured bedding hardness in the longitudinal direction of the track), with a (scale factor) as the wavelength parameter, the wavelength of the wavelet is varied. This results in a two-dimensional representation (the detected wavelengths are plotted against b, the position in the track).

With the help of the application of the fractal theory, the so-called fractal number can be calculated from track measurement data of the track. For this purpose, the length of a polygon, which is fitted into the measurement data, is calculated with an ever decreasing step size for a certain section length of a railway line, for example 200m. The following applies to the length of this polygon:

$$L ( d ) = n \cdot {d}^{1 - {D}_{r}}$$

L(d)=Length of the polygon; d=Polygon step size and Dr=Fractal dimension.

If the equation is logarithmised, the following applies:

$$log L ( d ) = ( 1 - {D}_{r} ) \cdot log ( d ) + log ( n )$$

In double logarithmic representation, regression lines are calculated (section by section). The slopes are always negative (the finer the subdivision, the larger the polygon length) and result in

$$k = 1 - {D}_{r}$$

k . . . Fractal number

Investigations show that the different slopes of the regression lines can be assigned to wavelength ranges and their causes.

According to the European standards, the typical wavelength ranges are divided into 4 categories. The causes of the track can be assigned to these categories based on practical experience and measurements.

TABLE 1
Wavelength ranges and assignment of track properties

| | Wavelength | | |
|---|---|---|---|
| Designation | range (m) | Description | Attributed cause |
| D0 | 0.5 < λ ≤ 3 | Shortwave | Sleeper interaction with |
| | (5) | | the ballast |
| D1 | 3 < λ ≤ 25 | Medium wave | Ballast contamination |
| D2 | 25 < λ ≤ 70 | Long wave | Mixed zone and |
| | | | underground problems |
| D3 | 70 < λ ≤ 150 | Large wave | Underground problems |

The table shows the categorisation of the wavelength ranges and the assignment of what causes the ripple.

The wavelength range D0 is not usually recorded and evaluated by electronic inspection measurement runs today. It is mainly caused by sleeper heights and reactions between the sleeper and rail fastening. Sleepers hitting the ballast form preferentially at 1.2 m and between 3 and 3.6 m (i.e. 2 and 5-6 times the usual sleeper spacing of 0.6 m).

The range D1 is the typical range in which quasiperiodic track defects are formed due to the movements of the railcar bodies and bogies. The dynamic loads acting on the rail cause ballast degradation. The consequences are ballast abrasion and ballast grain breakage. As a maintenance measure, the ballast is tamped or cleaned and the spoil replaced with new ballast.

D2 occurs in the mixed ballast—subsoil zone and in the subsoil. This range can also be improved by tamping and track cleaning.

The range D3 is due to subsoil problems; the long-wave fluctuations are often characterised by torsional fluctuations. The range D3 is characterised by insufficient load-bearing capacity. Possible causes are inadequate drainage, adjacent soil of low quality (loam, clay, peat), unsuitable subgrade material or a missing or too weak subgrade protection layer. This track defect can be remedied by fixing the drainage problem, improving and repairing the subgrade or replacing the soil.

According to the invention, the wavelet and fractal analysis is applied to the recorded measurement series. The expert system created in this way is used to train an artificial intelligence.

The AI model then automatically provides the position, extent and type of track defect. It also provides an indication of the general quality condition of the track and suggests the optimum maintenance method based on technical and economic calculations.

### BRIEF DESCRIPTION OF THE INVENTION

In the drawing, the invention is shown schematically in an embodiment example, wherein

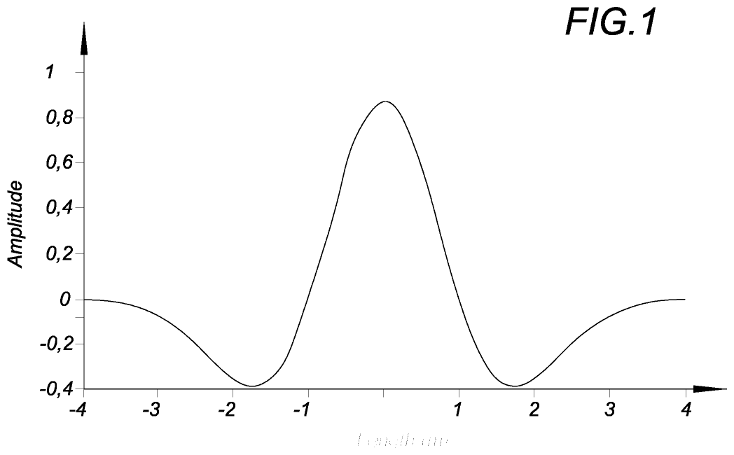

FIG. 1 shows an illustration of the Mexican hat wavelet,

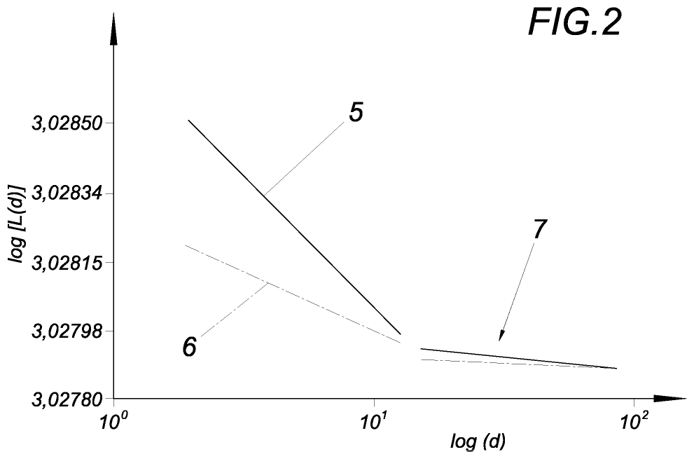

FIG. 2 shows a fractal plot of the track defect spectrum before and after track bed cleaning and

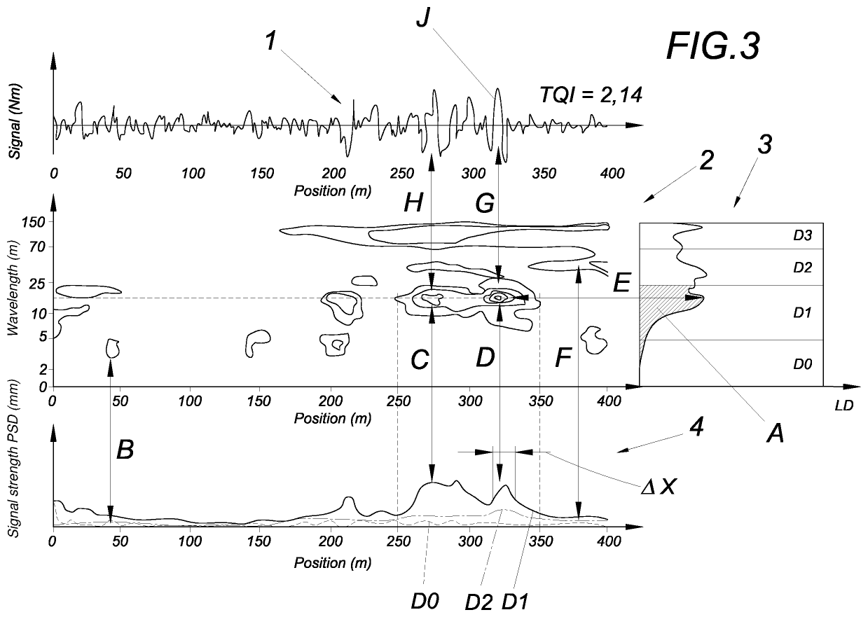

FIG. 3 shows an evaluation of a track defect measurement series using wavelet analysis.

### DESCRIPTION OF THE PREFERRED EMBODIMENTS

FIG. 1 shows an example of the shape of a wavelet—the so-called Mexican hat. For evaluation, the wavelet is pushed through the measurement series. Equal wavelength components of the signal are matched and generate a corresponding signal. As this evaluation is carried out with successive passes of different wavelengths, the result is a two-dimensional plot.

FIG. 2 shows the result of the fractal analysis of a track section before and after track cleaning. The influence can be clearly seen in the medium wavelength range 5, 6 (2-15 m), while it remains practically unaffected by the ballast bed cleaning in the long wavelength range. The flat slope in the long-wave range 7 indicates that the subsoil has sufficient load-bearing capacity and is in good condition. Track cleaning has improved the situation. However, it had no influence on the long-wave range. By tracking the change in the fractal number over the load on the track or the operating time, it is possible to draw conclusions about the remaining service life of the ballast and the rate of deterioration. Similarly, larger gradients in the long-wave range indicate subsurface problems. It is characteristic of fractal analysis that it can be carried out for any track length, for example, for entire lines or an entire rail network. It provides numerical sizes that are independent of the length of the analysed pattern.

Dirty ballast remains dirty even after tamping, and the subsoil conditions change little. Individual straight lines 5, 6, 7 indicate defects in the corresponding wavelength range. The steeper the straight lines 5, 6, the larger the influence of the defects. Fractal analysis is used as a second independent method for determining the defect wavelength bands. Although it provides the type and intensity of the defects, it does not indicate their location. It can only determine this information for the evaluated section and state that mostly track defects with this defect wavelength component are present in this section.

FIG. 3 shows the evaluation of a measurement signal using wavelet analysis. The measurement signal 1 (upper image area) can be a geometric measured variable (longitudinal height, direction, twist, track, transverse height) but also a physical one (rail temperature, ballast bed hardness, ballast bed stiffness, ballast damping or compaction force at the end of the tamping). The figure shows the TQI (track quality index), which was calculated, for example, from weighted standard deviations of the track geometric and physical measured variables. The larger the TQI, the worse the track. The TQI values must also be specified for each track class. A high-speed track travelling at 300 km/h has narrower tolerances than a freight wagon track with a maximum speed of 80 km/h.

The two-dimensional thermal image 2, calculated using wavelets (Morlet), is shown below the signal curve. If this is displayed in colour, the intensities of the defects can be clearly seen in terms of their location and extent. The wavelength is applied in the vertical direction and the position in the track is applied in the horizontal direction. As an example, 400 m sections are evaluated so that defect wavelengths of up to 200 m can still be analysed. The evaluation in the image shown takes into account defect wavelengths of up to 150 m and thus covers all four wavelength bands of interest from D0 to D3. The intensity of the defects can be seen in the thermal image as contour lines or in the form of colour grading. For example, defect J in the range of signal G1 can be seen in the thermal image 2 in the range of the D1 band at about 20 m wavelength. This is typically a defect caused by the condition of the ballast, which can be remedied by tamping. The defect can be located in the area between 250 and 350 m. Since there is also a defect at 220 m, tamping between 200 and 350 m is the best choice. In the D2 and D3 bands, there are portions that indicate a drainage problem and a bearing capacity problem in this area. This is to be seen as the actual cause of the track defects occurring in this area. The defect intensities for the three wavelength bands D0 to D2 are displayed in the lower diagram. These make it easier to assign the position and extent as well as the defect intensity. The wavelet power density spectrum LD can be seen to the right of the thermal image. The wavelength is plotted vertically and the power density horizontally. The wavelength bands are drawn in the diagram. To determine the average power density in a wavelength band, the integral (shown as A) is calculated. This is done for all four bands. Detecting the maximum values is also important, as they indicate the wavelengths at which the track defects are dominant. This method can also be used to detect individual defects (e.g. with the extent Dx in the image) and to indicate their position and extent.

According to Table 1 above, the type of defects can be assigned and, based on this, the optimum maintenance can be determined. The comparative LCC analysis can be used to justify why, for example, tamping (as in this case) is more favourable than track cleaning over this short area.

Marking B, for example, shows a short-wave track defect in the 40 metre range that is due to sleeper heights. At the same time, an image of the PSD spectrum shows that the intensity is low and therefore tamping is not yet necessary in this area. Mark F identifies a weakness in the boundary layer at a wavelength of around 35 m. It would be advisable to examine this section for effective drainage.

1. A method for automatic evaluation of wavelet-transformed track measurement data of the track geometry and/or a ballast bed of a track with a computing device, said method comprising:
firstly wavelet-transforming a measurement series of track measurement data to be evaluated, assigned to a track section, with a plurality of wavelets of different wavelengths so as to derive the wavelet-transformed track measurement data; and
forming a thermal image, in which a wavelength above a position in the track and the wavelet-transformed track measurement data are provided as thermal information, and
forming a wavelet power density spectrum from said wavelet-transformed track measurement data; and
calculating with the computing device a signal strength diagram for a plurality of wavelength ranges; and then
determining at least one of a type, a position, an extent and a size of track defects from the thermal image, including determining a local position, an extent, and associated wavelength ranges of predominant track defects.

2. The method according to claim 1, wherein integrals of power densities over the wavelength are formed in the wavelet power density spectrum so as to determine intensity of the track defects.

3. The method according to claim 1, wherein the determined track defects are assigned to wavelength ranges.

4. The method according to claim 2, wherein the intensity of the track defects is also determined according to a local extent and position of the thermal information in the thermal image.

5. The method according to claim 1, wherein the position and size of individual defects of the track defects are determined from the thermal image.

6. The method according to claim 1, wherein the measurement series of the track measurement data is analysed using a fractal analysis method with regard to a wavelength content thereof, wherein the track defects are automatically classified according to the analysed range of wavelengths with regard to the wavelength ranges, and wherein the method further comprises, based on gradients of the fractal lines from the fractal analysis, determining size and intensity of the track defects and calculating a state of the track.

7. The method according to claim 1, wherein an expert system formed in said method is used to train an artificial intelligence that automatically learns to determine track defects from data provided.

8. The method according to claim 1, wherein suggestions for rectifying the track defects are generated as a result of the evaluation.

9. The method according to claim 8, wherein results of the evaluation and suggestions for rectifying the track defects are automatically summarized in a report.

10. The method according to claim 8, wherein the method further comprises calculating and estimating the expected durability of tamping work from results of the evaluation.

11. The method according to claim 1, wherein the determining of the local position, the extent, and the associated wavelength ranges of the predominant track defects is from contour lines of the thermal image.

12. The method according to claim 2, wherein the integrals of the power densities are formed over the wavelength ranges in the wavelet power density spectrum so as to determine the intensity of the track defects.

13. The method according to claim 2, wherein the determined track defects are assigned to wavelength ranges.

14. The method according to claim 3, wherein wherein the intensity of the track defects is also determined according to a local extent and position of the thermal information in the thermal image.

15. The method according to claim 12, wherein wherein the intensity of the track defects is also determined according to a local extent and position of the thermal information in the thermal image.

16. The method according to claim 13, wherein wherein the intensity of the track defects is also determined according to a local extent and position of the thermal information in the thermal image.
